(19) United States
(12) Patent Application Publication
(10) Pub. No.: US 2026/0213889 A1
(43) Pub. Date: Jul. 23, 2026

(54) NETWORK CONTROLLED RADIO LINK CONTROL RETRANSMISSIONS

(71) Applicant: Lenovo (United States) Inc., Morrisville, NC (US)

(72) Inventors: Joachim Löhr, Wiesbaden (DE); Shwetha Sreejith, Steinbach (DE)

(73) Assignee: Lenovo (United States) Inc., Morrisville, NC (US)

(21) Appl. No.: 19/028,006

(22) Filed: Jan. 17, 2025

(51) Int. Cl. H04L 1/1867; H04L 1/1812; H04W 72/1268

(52) U.S. Cl. CPC H04L 1/189; H04L 1/1812; H04L 1/1874; H04W 72/1268

(57) ABSTRACT

Various aspects of the present disclosure relate to network controlled radio link control (RLC) retransmissions. A user equipment (UE) receives downlink control information (DCI) that indicates an RLC retransmission request for one or more RLC packet data units (PDUs) contained within a transport block (TB) associated with a hybrid automatic repeat request (HARQ) process. The UE triggers, based at least in part on the DCI, a RLC retransmission of the one or more RLC PDUs.

### TECHNICAL FIELD

The present disclosure relates to wireless communications, and more specifically to network controlled radio link control (RLC) retransmissions.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). By way of another example, a list of at least one of A; B; or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

A UE for wireless communication is described. The UE may be configured to, capable of, or operable to perform one or more operations as described herein. For example, the UE may be configured to, capable of, or operable to receive downlink control information (DCI) that indicates a radio link control (RLC) retransmission request for one or more RLC packet data units (PDUs) contained within a transport block (TB) associated with a hybrid automatic repeat request (HARQ) process; and trigger, based at least in part on the DCI, a RLC retransmission of the one or more RLC PDUs.

A processor (e.g., a standalone processor chipset, or a component of a UE) for wireless communication is described. The processor may be configured to, capable of, or operable to perform one or more operations as described herein. For example, the processor may be configured to, capable of, or operable to receive DCI that indicates a RLC retransmission request for one or more RLC PDUs contained within a TB associated with a HARQ process; and trigger, based at least in part on the DCI, a RLC retransmission of the one or more RLC PDUs.

A method performed or performable by a UE for wireless communication is described. The method may include receiving DCI that indicates a RLC retransmission request for one or more RLC PDUs contained within a TB associated with a HARQ process; and triggering, based at least in part on the DCI, a RLC retransmission of the one or more RLC PDUs.

In some implementations of the UE, the processor, and the method described herein, the DCI comprises an uplink (UL) DCI that allocates one or more physical uplink shared channel (PUSCH) resources.

In some implementations of the UE, the processor, and the method described herein, the UL DCI allocates PUSCH resources for a HARQ initial transmission.

In some implementations of the UE, processor, and method described herein, the UE, processor, and method may further be configured to, capable of, performed, performable, or operable to indicate, to an RLC transmitter (Tx) entity, an RLC sequence number (SN).

In some implementations of the UE, processor, and method described herein, the UE, processor, and method may further be configured to, capable of, performed, performable, or operable to indicate, to an RLC Tx entity, an RLC header of an RLC packet data unit (PDU) of the one or more RLC PDUs for which the RLC retransmission is requested.

In some implementations of the UE, processor, and method described herein, the UE, processor, and method may further be configured to, capable of, performed, performable, or operable to trigger transmission of one or more medium access control (MAC) control elements (MAC CEs) contained within the transport block based at least part on the received RLC retransmission request indication.

In some implementations of the UE, the processor, and the method described herein, the DCI indicates to perform the RLC retransmission instead of performing one or more HARQ retransmission of the TB.

In some implementations of the UE, processor, and method described herein, the UE, processor, and method may further be configured to, capable of, performed, performable, or operable to flush a HARQ buffer of the HARQ process associated with the TB.

In some implementations of the UE, processor, and method described herein, the UE, processor, and method may further be configured to, capable of, performed, performable, or operable to transmit the RLC retransmission of the one or more RLC PDUs prior to transmission of initial RLC PDUs during a logical channel prioritization (LCP) procedure.

In some implementations of the UE, processor, and method described herein, the UE, processor, and method may further be configured to, capable of, performed, performable, or operable to receive an indication of an RLC retransmission request from a lower layer of the UE; receive one or more RLC status reports from a corresponding receiving RLC entity; generate a consolidated RLC status report based at least in part on the requested retransmission request of the one or more RLC PDUs and based at least in part on the one or more RLC status reports received from the receiving RLC entity; and trigger the RLC retransmissions based on the consolidated RLC status report.

An NE (e.g., a base station) for wireless communication is described. The NE may be configured to, capable of, or operable to perform one or more operations as described herein. For example, the NE may be configured to, capable of, or operable to transmit DCI that indicates a RLC retransmission request for one or more RLC PDUs contained within a TB; and receive an RLC retransmission of the one or more RLC PDUs.

A processor (e.g., a standalone processor chipset, or a component of a NE (e.g., a base station)) for wireless communication is described. The processor may be configured to, capable of, or operable to perform one or more operations as described herein. For example, the processor may be configured to, capable of, or operable to transmit DCI that indicates a RLC retransmission request for one or more RLC PDUs contained within a TB; and receive an RLC retransmission of the one or more RLC PDUs.

A method performed or performable by an NE (e.g., a base station) for wireless communication is described. The method may include transmitting DCI that indicates a RLC retransmission request for one or more RLC PDUs contained within a TB; and receiving an RLC retransmission of the one or more RLC PDUs.

In some implementations of the NE, the processor, and the method described herein, the DCI comprises an UL DCI that allocates one or more PUSCH resources.

In some implementations of the NE, the processor, and the method described herein, the UL DCI allocates PUSCH resources for a HARQ initial transmission.

In some implementations of the NE, the processor, and the method described herein, the DCI indicates to perform the RLC retransmission instead of performing one or more HARQ retransmission of the TB.

### BRIEF DESCRIPTION OF THE DRAWINGS

FIG. 1 illustrates an example of a wireless communications system in accordance with aspects of the present disclosure.

FIG. 2 illustrates an example of wireless communication in accordance with aspects of the present disclosure.

FIG. 3 illustrates an example of packet data convergence protocol (PDCP) and RLC reception.

FIG. 4 illustrates an example of PDCP and RLC reception after expiration of a reordering timer (e.g., the t-Reordering timer).

FIG. 5 illustrates an example of a DCI format 500 for scheduling of PUSCH in accordance with aspects of the present disclosure.

FIG. 6 illustrates an example of a DCI format 600 for scheduling of PUSCH in accordance with aspects of the present disclosure.

FIG. 7 illustrates an example of a UE in accordance with aspects of the present disclosure.

FIG. 8 illustrates an example of a processor in accordance with aspects of the present disclosure.

FIG. 9 illustrates an example of a NE in accordance with aspects of the present disclosure.

FIG. 10 illustrates a flowchart of a method in accordance with aspects of the present disclosure.

FIG. 11 illustrates a flowchart of a method in accordance with aspects of the present disclosure.

### DETAILED DESCRIPTION

A network node (e.g., a NE, a UE, or both) may be configured with one or multiple protocol stacks, such as a control plane (CP)-protocol stack and a user plane (UP)-protocol stack. Each of the CP-protocol stack and the UP-protocol stack may include various protocol layers (also referred to as entities), including one or more of an application (APP) layer, a radio resource control (RRC) layer, a non-access stratum (NAS) layer, a PDCP layer, an RLC layer, a medium access control (MAC) layer, or a physical (PHY) layer. In 3rd Generation Partnership Project (3GPP) 5G New Radio (NR), PDCP and RLC layers of the UP-protocol stack may function independently from each other.

An RLC layer may be configured with one or more modes, including a transparent mode (TM), an unacknowledged mode (UM), and an acknowledged mode (AM). In the AM mode, the network node operable as a receiver (Rx) entity communicates (e.g., transmits, sends) an acknowledgment (a confirmation) to the network node operable as a transmitter (Tx) entity for each protocol data unit (PDU) received by the Rx entity.

An enhancement to the RLC AM mode is autonomous retransmissions. Autonomous retransmissions refer to retransmissions that are triggered at the RLC Tx entity without the transmitter receiving a status report (indicating a negative acknowledgement (NACK)) from its peer entity (the Rx entity). This allows, for example, retransmission of packets autonomously by the Tx entity so that the receiving entity receives the packets quickly without having to transmit a NACK to the Tx entity. Issues with autonomous transmissions include that to provide timely RLC retransmissions a poll bit may be set for RLC PDUs based on one or more conditions, such as delay-criticality, and autonomous RLC retransmission may be triggered proactively in the RLC Tx entity without receiving a status report. When applying those features in RLC there is a risk that the air interface is flooded with too many polls and/or too many unnecessary autonomous retransmissions, which can lead to congestion and reduction in the system capacity.

Various aspects of the present disclosure describe techniques allowing the triggering of fast RLC retransmissions at the RLC Tx entity, where those RLC retransmissions are under network (e.g., a gNB) control. For cases when there is no additional benefit in further subsequent HARQ retransmissions, the network (e.g., a gNB) may request by DCI signaling RLC retransmissions of one or more RLC PDUs included in a PUSCH TB. The present disclosure also describes signaling methods that allow the detection of HARQ feedback errors, e.g., NACK-to-acknowledgement (ACK) errors on PUCCH, at the Tx entity.

In various aspects of the present disclosure, the network (e.g., a gNB) indicates to the UE to trigger RLC retransmissions of at least some of the RLC PDUs included in a TB. The network (e.g., a gNB) indicates to the UE whether to perform a further HARQ retransmission of a TB associated with a HARQ process or whether to trigger RLC retransmissions of the RLC PDUs contained within the TB. The indication is signaled, for example, within a DCI/physical downlink control channel (PDCCH).

In various aspects of the present disclosure, the UE requests that the network (e.g., a gNB) trigger RLC retransmissions of the RLC PDUs contained in a TB. The UE signals within uplink control information the request for higher layer retransmission of the data, e.g., RLC PDUs, contained in a physical downlink shared channel (PDSCH). Based on the log likelihood ratios (LLRs), the UE may determine the probability of a successful decoding of a PDSCH transmission with further HARQ retransmission to be low hence indicate the request for higher layer retransmissions of the data, e.g., RLC PDUs, contained in the TB/PDSCH.

In various aspects of the present disclosure, the UE signals HARQ feedback information for the current TB received on a PDSCH for a HARQ process and for the previous TB received on the PDSCH for the same HARQ process. In order to be able to detect HARQ control channel errors at the network (e.g., a gNB), the UE signals HARQ feedback (ACK/NACK) information not only for the current transmission associated with a HARQ process, but also for the previous TB transmission for the same HARQ process.

A network (e.g., a gNB) enabling autonomous RLC retransmissions at the RLC Tx entity can lead to an increased number of unnecessary RLC retransmissions, e.g., the UE triggers unnecessarily an RLC retransmission even though the receiving entity may be able to decode the RLC PDU(s) correctly based on HARQ retransmissions. Those unnecessary RLC retransmissions which are triggered at the transmitter side without involvement of the RLC receiving entity will as a consequence reduce the system capacity. The techniques discussed herein avoid unnecessary RLC retransmissions by controlling autonomous RLC retransmissions at the receiving side. For example, when the network (e.g., a gNB) is not able to correctly decode a transport block, e.g., even after a number of HARQ retransmissions, the network (e.g., a gNB) may choose to order the UE to trigger RLC retransmissions of the RLC PDUs contained within the TB instead of requesting a further HARQ retransmissions of the TB. This allows for fast RLC retransmissions and at the same time avoids unnecessary autonomous retransmissions.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Reference is made herein to a lower layer of a network node, which is, for example, the physical layer of the protocol stack at the network node. Reference is also made herein to a higher layer of a network node, which is, for example, a layer higher than the physical layer of the protocol stack at the network node.

Aspects of the present disclosure are described in the context of a wireless communications system.

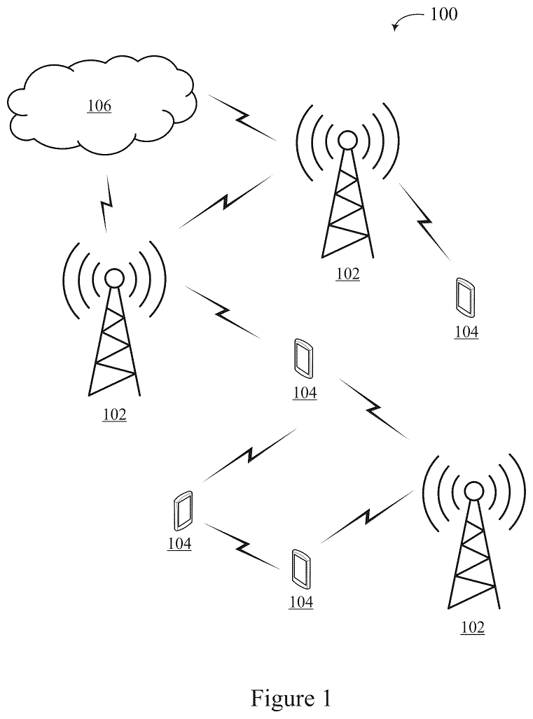

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WIMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a Tx device, a Rx device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a PDU session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing, and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

For a network node (e.g., a NE 102, a UE 104, or both) operable as a Rx entity, a PDCP layer may maintain a reordering window to receive (e.g., obtain) and transmit (e.g., submit, forward) PDCP PDUs to higher layers of a protocol stack. At an RLC layer of the Rx entity, the Rx entity may maintain a reception window to receive (e.g., obtain) and transmit (e.g., submit, forward) RLC PDUs to higher layers of the protocol stack. At the PDCP layer of the Rx entity, the reordering window may be controlled in accordance with a timer (e.g., t-Reordering timer), which may be configured by RRC. When the timer expires, the reordering window may slide (e.g., transition) forward, for example, the lower bound of the reordering window may be updated. If a packet is received outside of the reordering window, the packet may be discarded by the Rx entity at the PDCP layer of the Rx entity.

An RLC layer may be configured with one or more modes, including a transparent mode (TM), an unacknowledged mode (UM), and an acknowledged mode (AM). In the AM mode, the Rx entity may slide (e.g., update, transition) a reception window when a lowest packet in the window (e.g., a packet with a SN that matches a lower bound of an RLC AM reception window) has been completely received and an acknowledgement has been transmitted for the same. Because the PDCP and RLC layers function independently, the reception window and the reordering window may not be updated concurrently (e.g., at the same time). If the PDCP reordering window moves (e.g., slides, transitions) forward while the reception window is not updated, the RLC layer might transmit (e.g., submit, forward) packets to the PDCP layer that are outside of the reordering window leading to discarding (e.g., dropping) of such packets. The transmission of these packets not only wastes resources but also introduces unwanted latency to the UP.

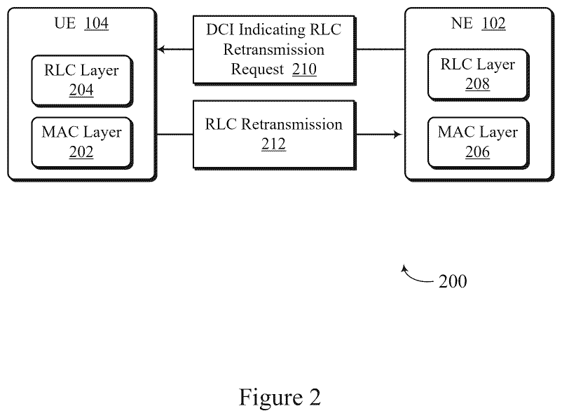

FIG. 2 illustrates an example 200 of wireless communication in accordance with aspects of the present disclosure. The example 200 includes a UE 104 and a NE 102. The UE 104 includes a MAC layer 202 and an RLC layer 204 that includes one or more RLC entities, and the NE 102 includes a MAC layer 206 and an RLC layer 208 that includes one or more RLC entities. The NE 102 communicates (e.g., signals, transmits, outputs) to the UE 104, a DCI 210 indicating an RLC retransmission request. The DCI 210 indicates to the UE 104 to trigger RLC retransmission of at least some of the RLC PDUs included in a TB. In response to the DCI 210, the UE 104 communicates (e.g., signals, transmits, outputs) the requested RLC transmission 212 to the NE 102.

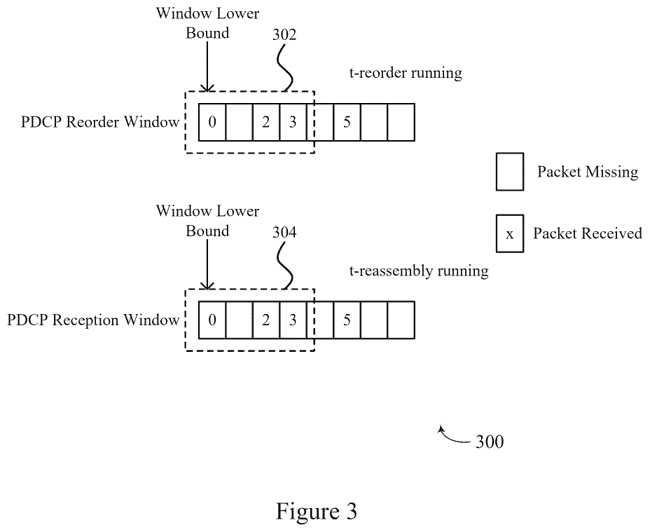

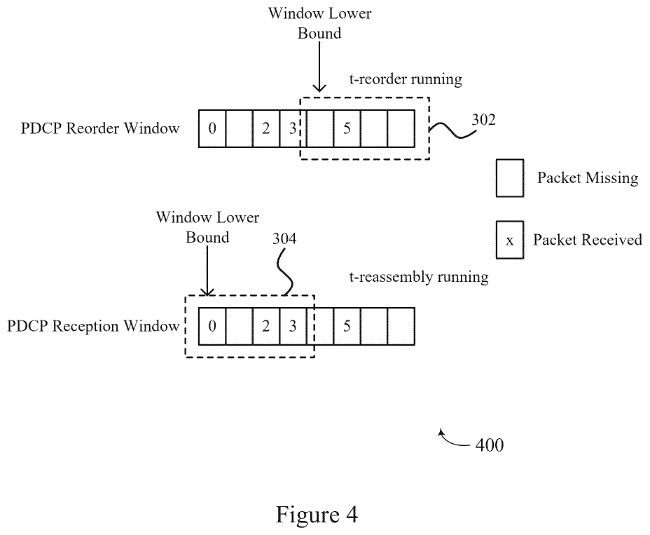

FIG. 3 illustrates an example 300 of PDCP and RLC reception. The example 300, along with the example 400 of FIG. 4 below, illustrates problems with conventional 5G NR. The example 300 shows the reordering window 302 in PDCP and the reception window 304 in RLC AM mode where the lower bounds of both windows are expecting PDU with SN=0 (COUNT=0 in case of PDCP where COUNT=[hyper frame number (HFN), SN]). The RLC receiving entity (e.g., UE 104 FIG. 2) has correctly and fully received packets numbered 0, 2 and 3, and hence transmitted these packets to the PDCP layer. The PDCP layer has also received packets numbered 0, 2 and 3, with a missing packet numbered 1. Hence the receiving entity starts a t-Reordering timer for PDCP when the PDCP layer receives packet 2 before 1. Additionally, the receiving entity starts a t-reassembly timer for RLC since one or more segments of packet 1 are not received yet. When the t-Reordering timer expires, the PDCP reordering window 302 updates its lower bound to the next packet that has not been consecutively received.

FIG. 4 illustrates an example 400 of PDCP and RLC reception after expiration of a reordering timer (e.g., the t-Reordering timer). In the example 400, packet 4 is the next packet that has not been consecutively received after the t-Reordering expired. Hence, the lower bound of the PDCP reordering window 302 is moved to packet 4, whereas in RLC, the t-reassembly only triggers a status report upon expiry and the reception window 304 does not update unless the status report contains an ACK for packet 1. Since the RLC receiving entity has not received packet 1, the RLC layer still tries to recover the packet by means of retransmissions. Once the packet is recovered by the RLC layer, the RLC layer transmits the packet to the PDCP layer which will discard the packet as the packet is outside of the reordering window. These redundant transmissions are not only a waste of resources but can also add unwanted latency on the user plane.

Returning to FIG. 2, for enhancements to the RLC AM mode, one approach is enabling autonomous retransmissions (e.g., signaling(s), communication(s)) as mentioned above. To achieve timely retransmissions on RLC layer (e.g., for extended reality (XR) traffic), one or more of the following options can be taken into consideration: autonomous retransmission (e.g., without status report) of PDUs based on some triggers (existing or new triggers can be considered), retransmission based on enhanced status report, or retransmission based on enhanced polling. Impact on capacity can also be considered. Focus on the enhancements for UL traffic can also be considered.

One issue with autonomous retransmissions is that they may quickly congest the link if the RLC transmits too many unnecessary autonomously retransmitted packets. This may further aggravate the delay encountered in data transmission. Another problem faced with autonomous retransmissions is that they may be redundant if triggered too early, e.g., before the initial transmission was received by the peer entity and/or if a packet was already ACKed but the RLC transmitter has not yet received the ACK. This redundancy can lead to reduced throughput and resource wastage. Additionally, the MAC HARQ may also be simultaneously trying to recover and/or correctly decode a TB when an autonomous retransmission is triggered in RLC. If the MAC HARQ is successful in decoding a TB consisting of an RLC PDU that was also autonomously retransmitted, the autonomous retransmission remains redundant leading to resource wastage, reduced throughput and increased latencies.

With respect to enhancements for timely retransmissions, whether existing mechanisms are insufficient to resolve the timely RLC retransmission problem and RLC enhancements for timely RLC retransmission can be taken into consideration. Excluding enhanced status reporting can also be taken into consideration. Focus on autonomous retransmission and polling enhancements, e.g., understanding how each option affects the capacity and packet delay, can also be taken into consideration. Timely RLC retransmission solution covering both autonomous retransmission and polling enhancement, and the network (e.g., an NE 102) configuring either or both of them, can also be taken into consideration.

The RLC enhancements providing timely RLC retransmissions being considered can include setting a poll bit for RLC PDUs based on one or more conditions, such as delay-criticality and autonomous RLC retransmission enhancements in RLC which are triggered proactively in the RLC Tx entity without receiving a status report. When applying those features in RLC there is a risk that the air interface is flooded with too many polls and/or too many unnecessary autonomous retransmissions which can lead to congestion and reduction in the system capacity.

This disclosure includes techniques allowing the triggering of fast RLC retransmission(s) at the RLC Tx entity, where those RLC retransmissions are under network (e.g., an NE 102) control. For cases when there is no additional benefit in further subsequent HARQ retransmissions, the network (e.g., an NE 102) may request by DCI signaling RLC retransmissions of the RLC PDU(s) included in a PUSCH TB. This disclosure also describes new signaling methods which allow the detection of HARQ feedback errors, e.g., NACK-to-ACK errors on physical uplink control channel (PUCCH), at the transmitting side, e.g., the network (e.g., an NE 102) side.

Polling enhancements can include setting a poll bit for RLC PDUs based on one or more conditions such as delay-criticality. For example, when the remaining time of a RLC PDU (e.g., based on the discardTimer or discardTimerforLowImportance) falls below a threshold value, the RLC transmitter sets a poll bit in order to trigger a status report. If the delay-critical PDU is indicated as a NACK in the status report, the RLC transmitter can retransmit the packet. If the delay-critical PDU is indicated as an ACK, the RLC transmitter may discard the packet as per legacy procedure.

The autonomous retransmission enhancements in RLC include triggering a proactive retransmission without receiving a status report. This may be done based on one or more preconfigured conditions such as delay-criticality. For example, when the remaining time of a RLC PDU (e.g., based on the discardTimer or discardTimerforLowImportance) falls below a threshold value, the RLC transmitter can retransmit the delay-critical PDU without waiting for a status report.

With the simultaneous configuration of both features in RLC, the RLC may be flooded with too many polls and/or autonomous retransmission which can lead to congestion and delays on the link.

One solution to having too many polls and/or autonomous retransmissions includes configuring a UE with an enhanced polling, an autonomous retransmission, or both, and allowing the RLC transmitter to perform legacy retransmissions and window updates (transmission window as well as reception window) based on the status reports as per legacy procedure. When the enhanced polling or autonomous retransmission (or both) are configured, the RLC transmitter will continue to perform legacy retransmissions on top of the enhanced polls/autonomous retransmissions which may cause additional delays on the link due to overflooding of packets.

Table 1 is a modulation and coding scheme (MCS) table for PUSCH transmissions.

TABLE 1

| MCS Index | Modulation | Target code Rate | Spectral |
|---|---|---|---|
| I_{MCS} | Order Qₘ | R × 1024 | efficiency |
| 0 | 1 | 240/q | 0.2344 |
| 1 | 1 | 314/q | 0.3066 |
| 2 | 2 | 193 | 0.3770 |
| 3 | 2 | 251 | 0.4902 |
| 4 | 2 | 308 | 0.6016 |
| 5 | 2 | 379 | 0.7402 |
| 6 | 2 | 449 | 0.8770 |
| 7 | 2 | 526 | 1.0273 |
| 8 | 2 | 602 | 1.1758 |
| 9 | 2 | 679 | 1.3262 |
| 10 | 4 | 340 | 1.3281 |
| 11 | 4 | 378 | 1.4766 |
| 12 | 4 | 434 | 1.6953 |
| 13 | 4 | 490 | 1.9141 |
| 14 | 4 | 553 | 2.1602 |
| 15 | 4 | 616 | 2.4063 |
| 16 | 4 | 658 | 2.5703 |
| 17 | 6 | 466 | 2.7305 |
| 18 | 6 | 517 | 3.0293 |
| 19 | 6 | 567 | 3.3223 |
| 20 | 6 | 616 | 3.6094 |
| 21 | 6 | 666 | 3.9023 |
| 22 | 6 | 719 | 4.2129 |
| 23 | 6 | 772 | 4.5234 |
| 24 | 6 | 822 | 4.8164 |
| 25 | 6 | 783 | 5.1152 |
| 26 | 6 | 910 | 5.3320 |
| 27 | 6 | 948 | 5.5547 |

| | | |
|---|---|---|
| 28 | q | reserved |
| 29 | 2 | reserved |
| 30 | 4 | reserved |
| 31 | 6 | reserved |

The network (e.g., the NE 102) indicates one or more RLC retransmissions by via a physical layer signaling. The network (e.g., the NE 102) indicates to the UE 104 to trigger RLC transmission(s) or retransmission(s) of at least some of the RLC PDU(s) included in a TB. In one or more implementations, the network (e.g., the NE 102) indicates to the UE 104 whether to perform a HARQ transmission or retransmission of a TB associated with a HARQ process or whether to trigger RLC transmissions or retransmissions of the RLC PDUs contained within the TB. In one example the indication is signaled within a DCI/PDCCH. For cases that the network (e.g., the NE 102) is not able to correctly decode a transport block, e.g., even after a number of HARQ transmissions or retransmissions, the network (e.g., the NE 102) may choose to order the UE 104 to trigger RLC retransmissions of the RLC PDUs contained within the TB instead of requesting further HARQ retransmissions of the TB. In situations where the link adaptation, e.g., selection of MCS, did not work well for the given channel conditions or when a carrier is heavily affected by interference (e.g., inter-cell interference), it may be more suitable to abort HARQ transmissions or retransmissions and rather trigger a retransmission on the RLC layer/level. RLC retransmissions may be scheduled with a different MCS or transport block size, and/or on a different carrier or cell. Triggering RLC transmissions or retransmissions on a PHY/MAC level will be faster compared to relying on an RLC status report for the respective RLC entities which triggers a RLC retransmission of the RLC PDUs contained in a TB. It should be also noted that the NE 102 (e.g., a gNB) is not aware of the exact content of a MAC PDU before correctly decoding a received TB. Therefore, the NE 102 (e.g., a gNB) cannot indicate to the corresponding RLC entities (for which one or more RLC PDUs are contained in a TB) to trigger a RLC status report.

In one or more implementations, the MAC level triggers the transmission or retransmission of a MAC CE in response to receiving an indication from the NE (e.g., a gNB) ordering the UE 104 to trigger an RLC retransmission of the RLC PDUs contained in a TB. For cases that the TB for which the indication to trigger RLC retransmission has been received also contains one or more MAC CEs, the MAC level triggers the transmission of such MAC CE(s) according to one example.

In one or more implementations, a field signaled within a DCI indicates to trigger RLC retransmissions of at least some of the RLC PDU(s) contained in the TB being transmitted for the corresponding HARQ process (as indicated by the HARQ process ID). According to one example, the DCI allocates resources for a PUSCH transmission. In one example the DCI schedules PUSCH resources for an initial HARQ transmission, e.g., new data indicator (NDI) toggled. The initial HARQ transmission refers to the first HARQ transmission of a transport block for a HARQ process. In one example, the field is a Boolean or a one-bit flag indicating whether to trigger RLC retransmissions or not for (at least some of) the RLC PDU(s) contained in the TB currently being under transmission for the HARQ process.

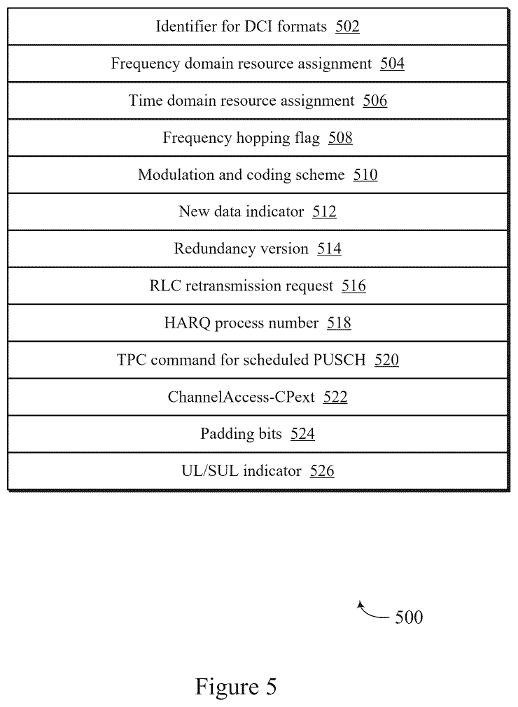

FIG. 5 illustrates an example of a DCI format 500 for scheduling of PUSCH in accordance with aspects of the present disclosure. The DCI format 500 is an example of DCI format 0_0 that is used for the scheduling of PUSCH in one cell.

In one or more implementations, the following information is transmitted by means of the DCI format 0_0 with cyclic redundancy check (CRC) scrambled by cell radio network temporary identifier (C-RNTI) or configured scheduling radio network temporary identifier (CS-RNTI) or MCS-C-RNTI. The DCI format 500 includes an identifier for DCI formats information element (IE) 502, which is 1 bit. The value of this bit field is set to 0, indicating an UL DCI format.

A frequency domain resource assignment IE 504 is a number of bits determined by the following, where BWP refers to bandwidth part and RB refers to resource block:

$$⌈ {log}_{2} ( {N}_{RB}^{UL , BWP} ( {N}_{RB}^{UL , BWP} + 1 ) / 2 ⌉$$

bits if neither of the higher layer parameters useInterlacePUCCH-PUSCH in BWP-UplinkCommon and useInterlacePUCCH-PUSCH in BWP-UplinkDedicated is configured, where

$${N}_{RB}^{UL , BWP}$$

is defined in clause 7.3.1.0 of 3GPP technical specification (TS) 38.214.
For PUSCH hopping with resource allocation type 1:
   N_{UL_hop} most significant bits (MSB) bits are used to indicate the frequency offset according to Clause 6.3 of 3GPP TS 38.214, where N_{UL_hop}=1 if the higher layer parameter frequencyHoppingOffsetLists contains two offset values and N_{UL_hop}=2 if the higher layer parameter frequencyHoppingOffsetLists contains four offset values,

$$⌈ {log}_{2} ( {N}_{RB}^{UL , BWP} ( {N}_{RB}^{UL , BWP} + 1 ) / 2 ⌉ - {N}_{UL\_hop}$$

bits provide the frequency domain resource allocation according to Clause 6.1.2.2.2 of 3GPP TS 38.214.
For non-PUSCH hopping with resource allocation type 1:

$$⌈ {log}_{2} ( {N}_{RB}^{UL , BWP} ( {N}_{RB}^{UL , BWP} + 1 ) / 2 ⌉$$

bits provide the frequency domain resource allocation according to Clause 6.1.2.2.2 of 3GPP TS 38.214.
If any of the higher layer parameters useInterlacePUCCH-PUSCH in BWP-UplinkCommon and useInterlacePUCCH-PUSCH in BWP-UplinkDedicated is configured:
   5+Y bits provide the frequency domain resource allocation according to Clause 6.1.2.2.3 of 3GPP TS 38.214 if the subcarrier spacing for the active UL bandwidth part is 30 kHz;
   6+Y bits provide the frequency domain resource allocation according to Clause 6.1.2.2.3 of 3GPP TS 38.214 if the subcarrier spacing for the active UL bandwidth part is 15 kHz.
If the DCI format 0_0 is monitored in a UE-specific search space, the value of Y is determined by

$$⌈ {log}_{2} ( \frac{{N}_{RB - set , UL}^{BWP} ( {N}_{RB , set , UL}^{BWP} + 1 )}{2} ) ⌉ where {N}_{RB - set , UL}^{BWP}$$

is the number of RB sets contained in the active UL BWP as defined in clause 7 of 3GPP TS38.214. If the DCI 0_0 is monitored in a common search space Y=0.

A time domain resource assignment IE 506 is 4 bits as defined in Clause 6.1.2.1 of 3GPP TS 38.214. A frequency hopping flag IE 508 is 1 bit according to Table 7.3.1.1.1-3, as defined in Clause 6.3 of 3GPP TS 38.214. A modulation and coding scheme IE 510 is 5 bits as defined in Clause 6.1.4.1 of 3GPP TS 38.214. A new data indicator IE 512 is 1 bit. A redundancy version IE 514 is 2 bits as defined in Table 7.3.1.1.1-2 of 3GPP TS 38.214.

An RLC retransmission request IE 516 is 1 bit. The RLC retransmission request indicates whether to trigger RLC retransmissions of at least some of the RLC PDU(s) contained in the TB being transmitted for the corresponding HARQ process (as indicated by the HARQ process ID).

A HARQ process number IE 518 is 4 bits. A transmit power control (TPC) command for scheduled PUSCH IE 520 is 2 bits as defined in Clause 7.1.1 of 3GPP TS 38.213. A ChannelAccess-CPext IE 522 is 2 bits indicating combinations of channel access type and CP extension as defined in Table 7.3.1.1.1-4 of 3GPP TS 38.214, or Table 7.3.1.1.1-4A of 3GPP TS 38.214 if channelAccessMode-r16=“semiStatic” is provided, for operation in a cell with shared spectrum channel access in frequency range 1; 2 bits indicating channel access type as defined in Table 7.3.1.1.1-4B of 3GPP TS 38.214 if ChannelAccessMode2-r17 is provided for operation in a cell in frequency range 2-2; 0 bit otherwise. One or more padding bits 524 are included, if required.

An UL/supplementary uplink (SUL) indicator IE 526 is 1 bit for UEs configured with supplementaryUplink in ServingCellConfig in the cell as defined in Table 7.3.1.1.1-1 of 3GPP TS 38.214 and the number of bits for DCI format 1_0 before padding is larger than the number of bits for DCI format 0_0 before padding; 0 bit otherwise. The UL/SUL indicator in the IE 526, if present, locates in the last bit position of DCI format 0_0, after the padding bit 524. If the UL/SUL indicator is present in DCI format 0_0 and the higher layer parameter pusch-Config is not configured on both UL and SUL the UE ignores the UL/SUL indicator field in DCI format 0_0, and the corresponding PUSCH scheduled by the DCI format 0_0 is for the UL or SUL for which high layer parameter pucch-Config is configured. If the UL/SUL indicator is not present in DCI format 0_0 and pucch-Config is configured, the corresponding PUSCH scheduled by the DCI format 0_0 is for the UL or SUL for which high layer parameter pucch-Config is configured. If the UL/SUL indicator is not present in DCI format 0_0 and pucch-Config is not configured, the corresponding PUSCH scheduled by the DCI format 0_0 is for the uplink on which the latest physical random access channel (PRACH) is transmitted.

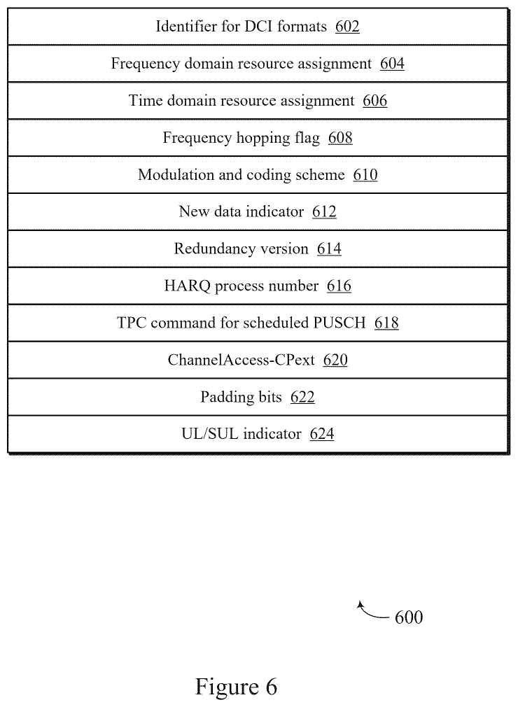

FIG. 6 illustrates an example of a DCI format 600 for scheduling of PUSCH in accordance with aspects of the present disclosure. The DCI format 600 is an example of DCI format 0_0 that is used for the scheduling of PUSCH in one cell.

In one or more implementations, the following information is transmitted by means of the DCI format 0_0 with CRC scrambled by temporary cell RNTI (TC-RNTI). The DCI format 600 includes an identifier for DCI formats IE 602, which is 1 bit. The value of this bit field is set to 0, indicating an UL DCI format.

The frequency domain resource assignment IE 604 is a number of bits determined by the following:

$$⌈ {log}_{2} ( {N}_{RB}^{UL , BWP} ( {N}_{RB}^{UL , BWP} + 1 ) / 2 ⌉$$

bits if the higher layer parameter useInterlacePUCCH-PUSCH in BWP-UplinkCommon is not configured, where N_{RB}^{UL, BWP} is the size of the initial UL bandwidth part.
   For PUSCH hopping with resource allocation type 1:
      N_{UL_hop} MSB bits are used to indicate the frequency offset according to Table 8.3-1 in Clause 8.3 of 3GPP TS 38.213, where N_{UL_hop}=1 if

$${N}_{RB}^{UL , BWP} < 50$$

and N_{UL_hop}=2 otherwise

$$⌈ {log}_{2} ( {N}_{RB}^{UL , BWP} ( {N}_{RB}^{UL , BWP} + 1 ) / 2 ⌉ - {N}_{UL\_hop}$$

bits provide the frequency domain resource allocation according to Clause 6.1.2.2.2 of 3GPP TS 38.214].
For non-PUSCH hopping with resource allocation type 1:

$$⌈ {log}_{2} ( {N}_{RB}^{UL , BWP} ( {N}_{RB}^{UL , BWP} + 1 ) / 2 ⌉$$

bits provide the frequency domain resource allocation according to Clause 6.1.2.2.2 of 3GPP TS 38.214.
If the higher layer parameter useInterlacePUCCH-PUSCH in BWP-UplinkCommon is configured:
   5 bits provide the frequency domain resource allocation according to Clause 6.1.2.2.3 of 3GPP TS 38.214 if the subcarrier spacing for the active UL bandwidth part is 30 kHz;
   6 bits provide the frequency domain resource allocation according to Clause 6.1.2.2.3 of 3GPP TS 38.214 if the subcarrier spacing for the active UL bandwidth part is 15 kHz.

The time domain resource assignment IE 606 is 4 bits as defined in Clause 6.1.2.1 of 3GPP TS 38.214. The frequency hopping flag IE 608 is 1 bit according to Table 7.3.1.1.1-3, as defined in Clause 6.3 of 3GPP TS 38.214. The modulation and coding scheme IE 610 is 5 bits. If the UE 104 requests repetition of PUSCH scheduled by random access response (RAR) UL grant as in 3GPP TS 38.321, the 5 bits are as described in Clause 6.1.2.1 and Clause 6.1.4.1 of 3GPP TS 38.214; otherwise, the 5 bits are as described in Clause 6.1.4.1 of 3GPP TS 38.214. A new data indicator IE 612 is 1 bit and is reserved. A redundancy version IE 614 is 2 bits as defined in Table 7.3.1.1.1-2 of 3GPP TS 38.214.

A HARQ process number IE 616 is 4 bits, reserved. A TPC command for scheduled PUSCH IE 618 is 2 bits as defined in Clause 7.1.1 of 3GPP TS 38.213. A Channel Access-CPext IE 620 is 2 bits indicating combinations of channel access type and CP extension as defined in Table 7.3.1.1.1-4 of 3GPP TS 38.214, or Table 7.3.1.1.1-4A of 3GPP TS 38.214 if channelAccessMode-r16=“semiStatic” is provided, for operation in a cell with shared spectrum channel access in frequency range 1; 2 bits indicating channel access type as defined in Table 7.3.1.1.1-4B of 3GPP TS 38.214 if ChannelAccessMode2-r17 is provided for operation in a cell in frequency range 2-2; 0 bit otherwise. One or more padding bits IE 622 are included, if required.

An UL/SUL indicator IE 624 is 1 bit if the cell has two ULs and the number of bits for DCI format 1_0 before padding is larger than the number of bits for DCI format 0_0 before padding; 0 bit otherwise. The UL/SUL indicator, if present, locates in the last bit position of DCI format 0_0, after the padding bit(s). If 1 bit, reserved, and the corresponding PUSCH is always on the same UL carrier as the previous transmission of the same TB.

Referring to DCI format 500 and DCI format 600, in one example a reserved code point of the one of the fields within a DCI or a combination of specific codepoints of existing fields within a DCI is indicating to trigger one or more RLC retransmissions of the (or at least some of the) RLC PDUs contained in the TB being transmitted for a HARQ process.

In one example, the indication to trigger RLC one or more retransmissions also indicates to stop the HARQ transmission or retransmission of the TB, e.g., no further HARQ retransmissions of the TB for the HARQ process.

Returning to FIG. 2, the behavior of the UE 104 upon reception of the DCI 210 requesting RLC retransmission is discussed.

The UE 104 indicates, in response to the reception of a signal from the network (e.g., NE 102) to the RLC entities for which one or more RLC PDUs are included in a TB associated with the HARQ process indicated in the signal, to trigger an RLC retransmission of the RLC PDUs which are included in the TB. In one implementation, the MAC layer of the UE 104, upon reception of the indication from PHY for a HARQ process, determines the RLC entities or logical channels (LCHs) of which RLC PDUs are included in the TB associated with the HARQ process, e.g., stored in the HARQ buffer of the HARQ process, and indicates to the corresponding RLC entities the RLC SN of the one or more RLC PDUs which are to be retransmitted. In one example, a MAC entity will indicate, to the corresponding RLC entities, the RLC header of the one or more RLC PDUs for which a retransmission shall be triggered. The RLC entity, upon reception of such indication from the MAC layer, will trigger the retransmission of the corresponding RLC PDU, e.g., RLC entities behave as having received an RLC status report indicating a NACK for the corresponding one or more RLC PDUs.

In one example, MAC is only indicating the RLC retransmission request to the RLC entities which are configured with acknowledged mode (AM).

In one or more implementations, the MAC entity/the UE 104 flushes the HARQ buffer of the HARQ process for which the RLC retransmission request was received, e.g., the DCI 210 indicating RLC retransmission request for a HARQ process.

In one or more implementations, the UE 104 transmits (e.g., communicates, signals) at least part of the RLC PDUs for which a retransmission was triggered by a DCI on the UL resources allocated by the same DCI. In one example, the RLC retransmissions triggered by the DCI are prioritized over other RLC PDUs during an LCP procedure, e.g., RLC PDUs.

In one example, the MAC/RLC prioritizes the RLC PDUs which were triggered by a DCI, e.g., DCI triggering a RLC retransmission, over other RLC PDUs during LCP procedure, e.g., RLC PDUs triggered by DCI are multiplexed first in a TB.

In one or more implementations, the RLC receiver combines DCI feedback and RLC status report to trigger RLC retransmissions and/or generate RLC retransmission PDUs. In one example, a transmitting RLC entity considers RLC retransmission requests received from the MAC layer and RLC status reports received from the RLC Rx entity, to handle or trigger the retransmission of one or more RLC service data units (SDUs) or service data unit (SDU) segments. A Tx RLC entity can generate a consolidated status report based on retransmission requests received from lower layer, e.g., upon reception of a DCI indicating to trigger one or more RLC retransmissions, and RLC status reports received from the peer Rx RLC entity.

In some situations, the UE 104 indicates a request for higher layer or RLC retransmission. In one or more implementations, the UE 104 indicates to the network (e.g., NE 102) the request of RLC retransmissions of the RLC PDUs contained in a TB. In one example, the UE 104 signals within uplink control information (UCI) the request for higher layer retransmission(s) of the data, e.g., RLC PDUs, contained in a PDSCH. Based on the log likelihood ratios (LLRs), the UE 104 may determine the probability of a successful decoding of a PDSCH transmission with further HARQ retransmission to be low hence indicate the request for higher layer retransmissions of the data, e.g. RLC PDU(s), contained in the TB/PDSCH. The network (e.g., NE 102) may schedule the RLC PDU(s) in a new TB with different MCS and/or on a different cell. Alternatively, the NE 102 (e.g., a gNB) may schedule the same TB (e.g., with a different MCS) on the same or different cell as a new initial transmission based on the received request from the UE 104. In that case the NE 102 (e.g., a gNB) may not trigger RLC retransmission(s) of the RLC PDUs contained in the TB. In one example, the UE 104 indicates the higher layer retransmission request on PUCCH. Additionally, or alternatively, the UE 104 indicates an ACK for the PDSCH together with the request for a higher layer retransmission. Additionally, or alternatively, the UE 104 indicates a NACK together with the request for higher layer retransmission.

In one or more implementations, a field (e.g., an IE) within the DCI 210 indicates to the UE 104 to transmit (e.g., communicate, signal) a TB which is currently stored in the HARQ buffer of a HARQ process (again) as an initial HARQ transmission on the allocated PUSCH resources. In one example, the field is signaled within an UL grant, e.g., DCI format 0_1, which indicates an initial HARQ transmission, e.g., NDI toggled, where the field is a one-bit field, e.g., one-bit flag, which when set to e.g., ‘1’ indicates the UE 104 is to transmit (e.g., communicate, signal) the TB which is currently stored in the HARQ buffer of the HARQ process indicated in the UL grant again as an initial HARQ transmission. The UE 104, upon reception of such UL grant indicating an initial HARQ transmission, will not perform an LCP procedure to generate a new TB, but take the TB which is stored in the corresponding HARQ buffer of the HARQ process. The network (e.g., NE 102) will ensure that the TB size indicated in the UL DCI is matching the size of the TB stored in the corresponding HARQ buffer. The UE 104 will act from MAC point of view as having received an UL grant for an initial HARQ transmission, e.g., re-initializing HARQ transmission counter, but will not perform an LCP procedure.

In one example the DCI 210 may contain a field (e.g., an IE) indicating a cell identifier, which indicates on which cell the initial HARQ transmission is to be performed by the UE 104.

In one or more implementations, a new RLC control PDU is sent by a transmitting RLC entity in order to request the peer receiving RLC entity to send a RLC status report. In one example, the transmission of the new RLC control PDU may be triggered by the RLC Tx UE 104 for cases when an RLC status report request has been triggered by the RLC Tx entity, however there is no RLC PDU available for transmission which could be used for including a poll bit.

Additionally, or alternatively, the RLC Tx entity generates a RLC PDU which includes no RLC data field, e.g., RLC header only, where in the RLC header the poll bit is set.

In one or more implementations, the UE 104 signals HARQ feedback information for the current TB received on a PDSCH for a HARQ process and for the previous TB received on the PDSCH for the same HARQ process. In order to be able to detect HARQ control channel errors at the NE 102 (e.g., a gNB), the UE 104 signals HARQ feedback (ACK/NACK) information not only for the current transmission associated with a HARQ process, but also for the previous TB transmission for the same HARQ process. In one example, the UE 104 signals the enhanced HARQ feedback information on a PUCCH to the NE 102 (e.g., a gNB). In one example, the enhanced HARQ feedback information is a two-bit field.

Sending HARQ feedback information for the previous TB for the same HARQ process allows the network (e.g., NE 102) to detect certain control channel errors. For example, in case a NACK to ACK error occurs, e.g., the UE 104 sends NACK but the NE 102 (e.g., a gNB) detects an ACK, the NE 102 (e.g., a gNB) will schedule a new TB on the PDSCH in response to the detection of an ACK assuming that the UE 104 could correctly decode the previous TB. In conventional systems NACK-to-ACK errors may lead to the loss of data packets or may require a higher layer retransmission (which increase the latency). When also signaling the HARQ feedback information for the previous TB, the NE 102 (e.g., a gNB) could identify that even though an ACK was detected that the previous TB was not correctly decoded by the UE 104. In one example, the enhanced HARQ feedback information is only sent for cases when the UE 104 receives a DCI with an NDI being toggled, e.g., for initial downlink (DL) transmissions. For PDSCH retransmission the UE 104 may send a legacy ACK/NACK on PUCCH.

Accordingly, this disclosure describes enhancements that provide for timely retransmissions of PDUs on RLC level while at the same time avoiding unnecessary autonomous RLC retransmissions. DCI requesting RLC retransmissions of the (at least some) RLC PDUs contained in a TB currently being transmitted on PUSCH is described. The MAC may also trigger transmission or retransmission of one or more MAC CEs contained in the TB. The MAC may flush HARQ process upon reception of a DCI indicating the request of RLC retransmissions.

The UE indicating the request of a higher layer retransmission of the RLC PDU contained in the PDSCH (DL) TB is also described. Higher layer retransmission request is transmitted on PUCCH together with HARQ feedback information.

A new field within a DCI indicates to the UE to transmit (e.g., communicate, signal) a TB which is currently stored in the HARQ buffer of a HARQ process (again) as an initial HARQ transmission on the allocated PUSCH resources. The MAC does not trigger LCP upon reception of initial UL grant indicating to transmit (e.g., communicate, signal) the same TB again.

Also described is a new RLC control PDU is sent by a Tx RLC entity in order to request the peer Rx RLC entity to send a RLC status report for cases when no RLC PDU is available for sending a polling bit. Also described is an RLC Tx entity generates a RLC PDU which includes no RLC data field, e.g., RLC header only, where in the RLC header the poll bit is set. Also described is a UE signals HARQ feedback information for the current TB received on a PDSCH for a HARQ process and for the previous TB received on the PDSCH for the same HARQ process in order to allow a NE (e.g., a gNB) to detect HARQ control channel errors

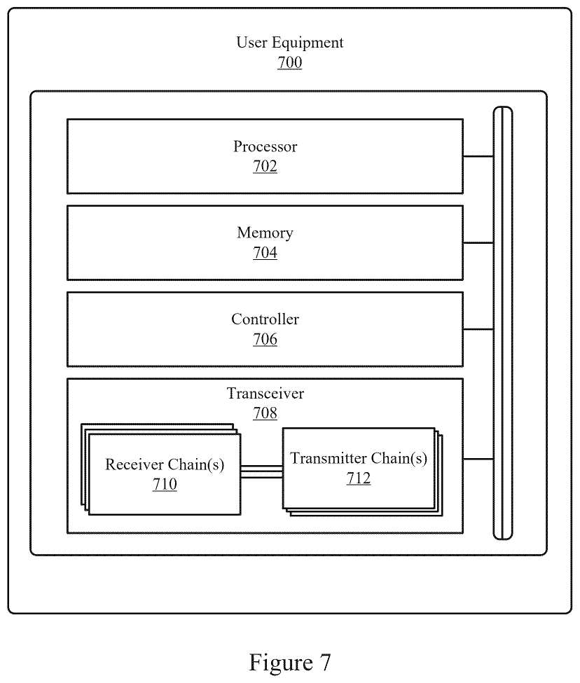

FIG. 7 illustrates an example of a UE 700 in accordance with aspects of the present disclosure. The UE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the UE 700 to perform various functions of the present disclosure.

The memory 704 may include volatile or non-volatile memory. The memory 704 may store computer-readable, computer-executable code including instructions when executed by the processor 702 cause the UE 700 to perform various functions described herein. The code may be stored in a non-transitory computer-readable medium such as the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the UE 700 to perform one or more of the functions described herein (e.g., executing, by the processor 702, instructions stored in the memory 704). For example, the processor 702 may support wireless communication at the UE 700 in accordance with examples as disclosed herein. The UE 700 may be configured to or operable to support a means for receiving DCI that indicates a RLC retransmission request for one or more RLC PDUs contained within a TB associated with a HARQ process; and triggering, based at least in part on the DCI, a RLC retransmission of the one or more RLC PDUs.

Additionally, the UE 700 may be configured to support any one or combination of where the DCI comprises an UL DCI that allocates one or more PUSCH resources; where the UL DCI allocates PUSCH resources for a HARQ initial transmission; indicating, to an RLC Tx entity, an RLC SN; indicating, to an RLC Tx entity, an RLC header of an RLC PDU of the one or more RLC PDUs for which the RLC retransmission is requested; triggering transmission of one or more MAC CEs contained within the transport block based at least part on the received RLC retransmission request indication; where the DCI indicates to perform the RLC retransmission instead of performing one or more HARQ retransmission of the TB; flushing a HARQ buffer of the HARQ process associated with the TB; transmitting the RLC retransmission of the one or more RLC PDUs prior to transmission of initial RLC PDUs during a LCP procedure; receiving an indication of an RLC retransmission request from a lower layer of the UE; receiving one or more RLC status reports from a corresponding receiving RLC entity; generating a consolidated RLC status report based at least in part on the requested retransmission request of the one or more RLC PDUs and based at least in part on the one or more RLC status reports received from the receiving RLC entity; and triggering the RLC retransmissions based on the consolidated RLC status report.

Additionally, or alternatively, the UE 700 may support at least one memory (e.g., the memory 704) and at least one processor (e.g., the processor 702) coupled with the at least one memory and configured to cause the UE to: receive DCI that indicates a RLC retransmission request for one or more RLC PDUs contained within a TB associated with a HARQ process; and trigger, based at least in part on the DCI, a RLC retransmission of the one or more RLC PDUS.

Additionally, the UE 700 may be configured to support any one or combination of where the DCI comprises an UL DCI that allocates one or more PUSCH resources; where the UL DCI allocates PUSCH resources for a HARQ initial transmission; where the at least one processor is further configured to cause the UE to indicate, to an RLC Tx entity, an RLC SN; where the at least one processor is further configured to cause the UE to indicate, to an RLC Tx entity, an RLC header of an RLC PDU of the one or more RLC PDUs for which the RLC retransmission is requested; where the at least one processor is further configured to cause the UE to trigger transmission of one or more MAC CEs contained within the transport block based at least part on the received RLC retransmission request indication; where the DCI indicates to perform the RLC retransmission instead of performing one or more HARQ retransmission of the TB; where the at least one processor is further configured to cause the UE to flush a HARQ buffer of the HARQ process associated with the TB; where the at least one processor is further configured to cause the UE to transmit the RLC retransmission of the one or more RLC PDUs prior to transmission of initial RLC PDUs during a LCP procedure; where the at least one processor is further configured to cause a first RLC transmitting entity of the UE to receive an indication of an RLC retransmission request from a lower layer of the UE; receive one or more RLC status reports from a corresponding receiving RLC entity; generate a consolidated RLC status report based at least in part on the requested retransmission request of the one or more RLC PDUs and based at least in part on the one or more RLC status reports received from the receiving RLC entity; and trigger the RLC retransmissions based on the consolidated RLC status report.

The controller 706 may manage input and output signals for the UE 700. The controller 706 may also manage peripherals not integrated into the UE 700. In some implementations, the controller 706 may utilize an operating system such as iOS®, ANDROID®, WINDOWS®, or other operating systems. In some implementations, the controller 706 may be implemented as part of the processor 702.

In some implementations, the UE 700 may include at least one transceiver 708. In some other implementations, the UE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas to receive a signal over the air or wireless medium. The receiver chain 710 may include at least one amplifier (e.g., a low-noise amplifier (LNA)) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

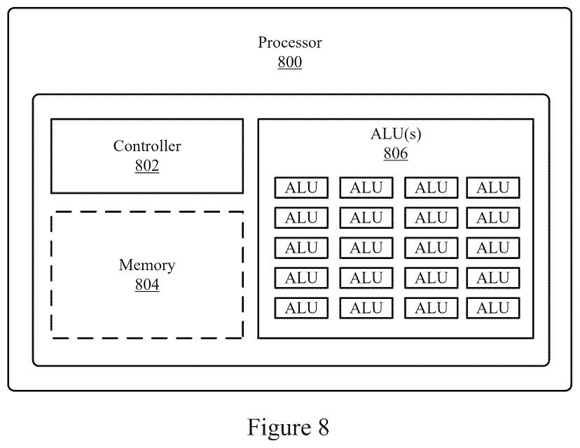

FIG. 8 illustrates an example of a processor 800 in accordance with aspects of the present disclosure. The processor 800 may be an example of a processor configured to perform various operations in accordance with examples as described herein. The processor 800 may include a controller 802 configured to perform various operations in accordance with examples as described herein. The processor 800 may optionally include at least one memory 804, which may be, for example, an L1/L2/L3 cache. Additionally, or alternatively, the processor 800 may optionally include one or more arithmetic-logic units (ALUs) 806. One or more of these components may be in electronic communication or otherwise coupled (e.g., operatively, communicatively, functionally, electronically, electrically) via one or more interfaces (e.g., buses).

The processor 800 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 800) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 802 may be configured to manage and coordinate various operations (e.g., signaling, receiving, obtaining, retrieving, transmitting, outputting, forwarding, storing, determining, identifying, accessing, writing, reading) of the processor 800 to cause the processor 800 to support various operations in accordance with examples as described herein. For example, the controller 802 may operate as a control unit of the processor 800, generating control signals that manage the operation of various components of the processor 800. These control signals include enabling or disabling functional units, selecting data paths, initiating memory access, and coordinating timing of operations.

The controller 802 may be configured to fetch (e.g., obtain, retrieve, receive) instructions from the memory 804 and determine subsequent instruction(s) to be executed to cause the processor 800 to support various operations in accordance with examples as described herein. The controller 802 may be configured to track memory addresses of instructions associated with the memory 804. The controller 802 may be configured to decode instructions to determine the operation to be performed and the operands involved. For example, the controller 802 may be configured to interpret the instruction and determine control signals to be output to other components of the processor 800 to cause the processor 800 to support various operations in accordance with examples as described herein. Additionally, or alternatively, the controller 802 may be configured to manage flow of data within the processor 800. The controller 802 may be configured to control transfer of data between registers, ALUs 806, and other functional units of the processor 800.

The memory 804 may include one or more caches (e.g., memory local to or included in the processor 800 or other memory, such as RAM, ROM, DRAM, SDRAM, SRAM, MRAM, flash memory, etc. In some implementations, the memory 804 may reside within or on a processor chipset (e.g., local to the processor 800). In some other implementations, the memory 804 may reside external to the processor chipset (e.g., remote to the processor 800).

The memory 804 may store computer-readable, computer-executable code including instructions that, when executed by the processor 800, cause the processor 800 to perform various functions described herein. The code may be stored in a non-transitory computer-readable medium such as system memory or another type of memory. The controller 802 and/or the processor 800 may be configured to execute computer-readable instructions stored in the memory 804 to cause the processor 800 to perform various functions. For example, the processor 800 and/or the controller 802 may be coupled with or to the memory 804, the processor 800, and the controller 802, and may be configured to perform various functions described herein. In some examples, the processor 800 may include multiple processors and the memory 804 may include multiple memories. One or more of the multiple processors may be coupled with one or more of the multiple memories, which may, individually or collectively, be configured to perform various functions herein.

The one or more ALUs 806 may be configured to support various operations in accordance with examples as described herein. In some implementations, the one or more ALUs 806 may reside within or on a processor chipset (e.g., the processor 800). In some other implementations, the one or more ALUs 806 may reside external to the processor chipset (e.g., the processor 800). One or more ALUs 806 may perform one or more computations such as addition, subtraction, multiplication, and division on data. For example, one or more ALUs 806 may receive input operands and an operation code, which determines an operation to be executed. One or more ALUs 806 may be configured with a variety of logical and arithmetic circuits, including adders, subtractors, shifters, and logic gates, to process and manipulate the data according to the operation. Additionally, or alternatively, the one or more ALUs 806 may support logical operations such as AND, OR, exclusive-OR (XOR), not-OR (NOR), and not-AND (NAND), enabling the one or more ALUs 806 to handle conditional operations, comparisons, and bitwise operations.

The processor 800 may support wireless communication in accordance with examples as disclosed herein. The processor 800 may be configured to or operable to support at least one controller (e.g., the controller 802) coupled with at least one memory (e.g., the memory 804) and configured to cause the processor to: receive DCI that indicates a RLC retransmission request for one or more RLC PDUs contained within a TB associated with a HARQ process; and trigger, based at least in part on the DCI, a RLC retransmission of the one or more RLC PDUs.

Additionally, the processor 800 may be configured to or operable to support any one or combination of where the DCI comprises an UL DCI that allocates one or more PUSCH resources; where the UL DCI allocates PUSCH resources for a HARQ initial transmission; where the at least one controller is further configured to cause the processor to indicate, to an RLC Tx entity, an RLC SN; where the at least one controller is further configured to cause the processor to indicate, to an RLC Tx entity, an RLC header of an RLC PDU of the one or more RLC PDUs for which the RLC retransmission is requested; where the at least one controller is further configured to cause the processor to trigger transmission of one or more MAC CEs contained within the transport block based at least part on the received RLC retransmission request indication; where the DCI indicates to perform the RLC retransmission instead of performing one or more HARQ retransmission of the TB; where the at least one controller is further configured to cause the processor to flush a HARQ buffer of the HARQ process associated with the TB; where the at least one controller is further configured to cause the processor to transmit the RLC retransmission of the one or more RLC PDUs prior to transmission of initial RLC PDUs during a LCP procedure; where the at least one controller is further configured to cause a first RLC transmitting entity of the processor to: receive an indication of an RLC retransmission request from a lower layer of the processor, receive one or more RLC status reports from a corresponding receiving RLC entity; generate a consolidated RLC status report based at least in part on the requested retransmission request of the one or more RLC PDUs and based at least in part on the one or more RLC status reports received from the receiving RLC entity; and trigger the RLC retransmissions based on the consolidated RLC status report.

The processor 800 may support wireless communication in accordance with examples as disclosed herein. The processor 800 may be configured to or operable to support at least one controller (e.g., the controller 802) coupled with at least one memory (e.g., the memory 804) and configured to cause the processor to: transmit DCI that indicates a RLC retransmission request for one or more RLC PDUs contained within a TB; and receive an RLC retransmission of the one or more RLC PDUs.

Additionally, the processor 800 may be configured to or operable to support any one or combination of where the DCI comprises an UL DCI that allocates one or more PUSCH resources; where the UL DCI allocates PUSCH resources for a HARQ initial transmission; where the DCI indicates to perform the RLC retransmission instead of performing one or more HARQ retransmission of the TB.

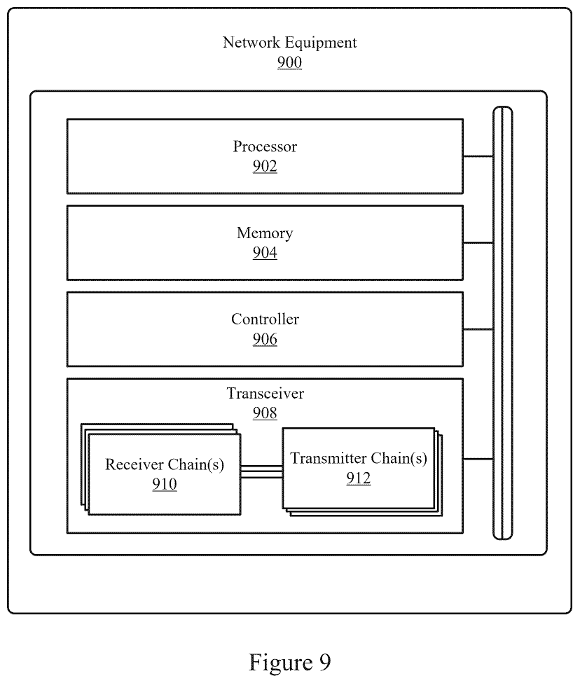

FIG. 9 illustrates an example of a NE 900 in accordance with aspects of the present disclosure. The NE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a CPU, an ASIC, an FPGA, or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the NE 900 to perform various functions of the present disclosure.

The memory 904 may include volatile or non-volatile memory. The memory 904 may store computer-readable, computer-executable code including instructions when executed by the processor 902 cause the NE 900 to perform various functions described herein. The code may be stored in a non-transitory computer-readable medium such as the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the NE 900 to perform one or more of the functions described herein (e.g., executing, by the processor 902, instructions stored in the memory 904). For example, the processor 902 may support wireless communication at the NE 900 in accordance with examples as disclosed herein. The NE 900 may be configured to support a means for transmitting DCI that indicates a RLC retransmission request for one or more RLC PDUs contained within a TB; and receiving an RLC retransmission of the one or more RLC PDUs.

Additionally, the NE 900 may be configured to support any one or combination of where the DCI comprises an UL DCI that allocates one or more PUSCH resources; where the UL DCI allocates PUSCH resources for a HARQ initial transmission; where the DCI indicates to perform the RLC retransmission instead of performing one or more HARQ retransmission of the TB.

Additionally, or alternatively, the NE 900 may support at least one memory (e.g., the memory 904) and at least one processor (e.g., the processor 902) coupled with the at least one memory and configured to cause the NE to: transmit DCI that indicates a RLC retransmission request for one or more RLC PDUs contained within a TB; and receive an RLC retransmission of the one or more RLC PDUs.

Additionally, the NE 900 may be configured to support any one or combination of where the DCI comprises an UL DCI that allocates one or more PUSCH resources; where the UL DCI allocates PUSCH resources for a HARQ initial transmission; where the DCI indicates to perform the RLC retransmission instead of performing one or more HARQ retransmission of the TB.

The controller 906 may manage input and output signals for the NE 900. The controller 906 may also manage peripherals not integrated into the NE 900. In some implementations, the controller 906 may utilize an operating system such as iOS®, ANDROID®, WINDOWS®, or other operating systems. In some implementations, the controller 906 may be implemented as part of the processor 902.

In some implementations, the NE 900 may include at least one transceiver 908. In some other implementations, the NE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas to receive a signal over the air or wireless medium. The receiver chain 910 may include at least one amplifier (e.g., a low-noise amplifier (LNA)) configured to amplify the received signal. The receiver chain 910 may include at least one demodulator configured to demodulate the receive signal and obtain the transmitted data by reversing the modulation technique applied during transmission of the signal. The receiver chain 910 may include at least one decoder for decoding the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

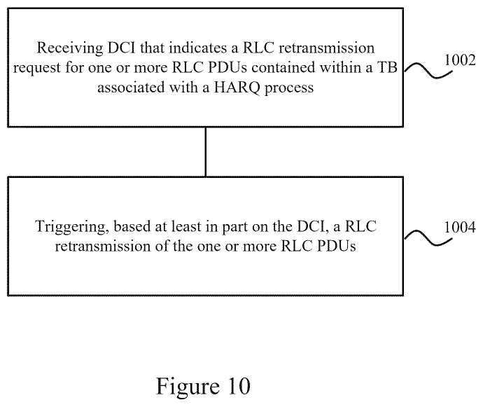

FIG. 10 illustrates a flowchart of a method in accordance with aspects of the present disclosure. The operations of the method may be implemented by a UE as described herein. In some implementations, the UE may execute a set of instructions to control the function elements of the UE to perform the described functions.

At 1002, the method may include receiving DCI that indicates a RLC retransmission request for one or more RLC PDUs contained within a TB associated with a HARQ process. The operations of 1002 may be performed in accordance with examples as described herein. In some implementations, aspects of the operations of 1002 may be performed by a UE as described with reference to FIG. 7.

At 1004, the method may include triggering, based at least in part on the DCI, a RLC retransmission of the one or more RLC PDUs. The operations of 1004 may be performed in accordance with examples as described herein. In some implementations, aspects of the operations of 1004 may be performed by a UE as described with reference to FIG. 7.

It should be noted that the method described herein describes a possible implementation, and that the operations and the steps may be rearranged or otherwise modified and that other implementations are possible.

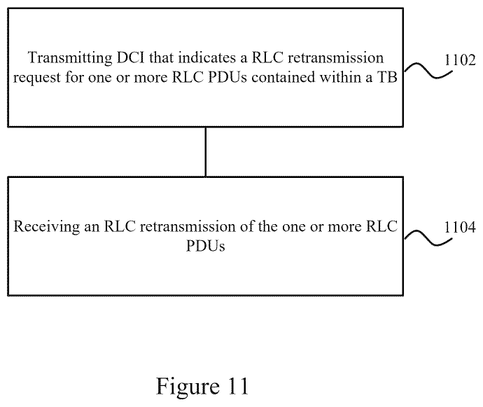

FIG. 11 illustrates a flowchart of a method in accordance with aspects of the present disclosure. The operations of the method may be implemented by a NE as described herein. In some implementations, the NE may execute a set of instructions to control the function elements of the NE to perform the described functions.

At 1102, the method may include transmitting DCI that indicates a RLC retransmission request for one or more RLC PDUs contained within a TB. The operations of 1102 may be performed in accordance with examples as described herein. In some implementations, aspects of the operations of 1102 may be performed by a NE as described with reference to FIG. 9.

At 1104, the method may include receiving an RLC retransmission of the one or more RLC PDUs. The operations of 1104 may be performed in accordance with examples as described herein. In some implementations, aspects of the operations of 1104 may be performed by a NE as described with reference to FIG. 9.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive downlink control information (DCI) that indicates a radio link control (RLC) retransmission request for one or more RLC packet data units (PDUs) contained within a transport block (TB) associated with a hybrid automatic repeat request (HARQ) process; and
trigger, based at least in part on the DCI, a RLC retransmission of the one or more RLC PDUs.

2. The UE of claim 1, wherein the DCI comprises an uplink (UL) DCI that allocates one or more physical uplink shared channel (PUSCH) resources.

3. The UE of claim 2, wherein the UL DCI allocates PUSCH resources for a HARQ initial transmission.

4. The UE of claim 1, wherein the at least one processor is further configured to cause the UE to indicate, to an RLC transmitter (Tx) entity, an RLC sequence number (SN).

5. The UE of claim 1, wherein the at least one processor is further configured to cause the UE to indicate, to an RLC transmitter (Tx) entity, an RLC header of an RLC PDU of the one or more RLC PDUs for which the RLC retransmission is requested.

6. The UE of claim 1, wherein the at least one processor is further configured to cause the UE to trigger transmission of one or more medium access control (MAC) control elements (MAC CEs) contained within the transport block based at least part on the received RLC retransmission request indication.

7. The UE of claim 1, wherein the DCI indicates to perform the RLC retransmission instead of performing one or more hybrid automatic repeat request (HARQ) retransmission of the TB.

8. The UE of claim 1, wherein the at least one processor is further configured to cause the UE to flush a hybrid automatic repeat request (HARQ) buffer of the HARQ process associated with the TB.

9. The UE of claim 1, wherein the at least one processor is further configured to cause the UE to transmit the RLC retransmission of the one or more RLC PDUs prior to transmission of initial RLC PDUs during a logical channel prioritization (LCP) procedure.

10. The UE of claim 1, wherein the at least one processor is further configured to cause a first RLC transmitting entity of the UE to:
receive an indication of an RLC retransmission request from a lower layer of the UE;
receive one or more RLC status reports from a corresponding receiving RLC entity;
generate a consolidated RLC status report based at least in part on the requested retransmission request of the one or more RLC PDUs and based at least in part on the one or more RLC status reports received from the receiving RLC entity; and
trigger the RLC retransmissions based on the consolidated RLC status report.

11. A base station for wireless communication, comprising:
at least one memory, and
at least one processor coupled with the at least one memory and configured to cause the base station to:
transmit downlink control information (DCI) that indicates a radio link control (RLC) retransmission request for one or more RLC packet data units (PDUs) contained within a transport block (TB); and
receive an RLC retransmission of the one or more RLC PDUs.

12. The base station of claim 11, wherein the DCI comprises an uplink (UL) DCI that allocates one or more physical uplink shared channel (PUSCH) resources.

13. The base station of claim 12, wherein the UL DCI allocates PUSCH resources for a hybrid automatic repeat request (HARQ) initial transmission.

14. The base station of claim 11, wherein the DCI indicates to perform the RLC retransmission instead of performing one or more hybrid automatic repeat request (HARQ) retransmission of the TB.

15. A processor for wireless communication, comprising:
at least one controller coupled with at least one memory and configured to cause the processor to:
receive downlink control information (DCI) that indicates a radio link control (RLC) retransmission request for one or more RLC packet data units (PDUs) contained within a transport block (TB) associated with a hybrid automatic repeat request (HARQ) process; and
trigger, based at least in part on the DCI, a RLC retransmission of the one or more RLC PDUs.

16. The processor of claim 15, wherein the DCI comprises an uplink (UL) DCI that allocates one or more physical uplink shared channel (PUSCH) resources.

17. The processor of claim 16, wherein the UL DCI allocates PUSCH resources for a HARQ initial transmission.

18. The processor of claim 15, wherein the at least one controller is further configured to cause the processor to indicate, to an RLC transmitter (Tx) entity, an RLC sequence number (SN).

19. A method performed by a user equipment (UE), the method comprising:
receiving downlink control information (DCI) that indicates a radio link control (RLC) retransmission request for one or more RLC packet data units (PDUs) contained within a transport block (TB) associated with a hybrid automatic repeat request (HARQ) process; and
triggering, based at least in part on the DCI, a RLC retransmission of the one or more RLC PDUs.

20. The method of claim 19, further comprising indicating, to an RLC transmitter (Tx) entity, an RLC header of an RLC PDU of the one or more RLC PDUs for which the RLC retransmission is requested.
